(19) United States
(12) Patent Application Publication
(10) Pub. No.: US 2007/0143128 A1
(43) Pub. Date: Jun. 21, 2007

(54) Method and system for providing customized recommendations to users

(76) Inventors: Maxim Lvovich Tokarev, Moscow (RU); Ilya Akselrod, Moscow (RU); Smirin Shahar (Boris), Moscow (RU); Vadim Drujina, Tel-Aviv (IL)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/314,519

(22) Filed: Dec. 20, 2005

(51) Int. Cl. G06Q 99/00

(52) U.S. Cl. 705/1; 715/705

(57) ABSTRACT

In one embodiment, a method includes transforming ratings provided by users for an object of interest into one or more correlated recommendations based on the level of trust of a recommendation recipient towards the users, and presenting the correlated recommendations to the recommendation recipient.

### RELATED APPLICATIONS

This application claims the benefit of U.S. Provisional Application No. ______, filed Jan. 11, 2005, entitled “A METHOD AND SYSTEM FOR PROVIDING USER SPECIFIC RECOMMENDED RESPONSES TO A USER INQUIRY.”

### FIELD

Embodiments of the invention relate generally to information retrieval systems, and more specifically to providing customized recommendations to users.

### BACKGROUND

The need to make choices is an essential part of anyone's life nowadays. As amount of options in each field is drastically growing in the modern world of globalization and technology advance, the complexity of making the right and informed choice becomes enormous.

Currently available online tools that assist users in making choices include, for example, “Yellow Pages”-like directories and posted public ratings of products and services. However, the “Yellow Pages”-like directories provide only a plain list of options and the publicly available ratings are often commercially sponsored. Users may also use search engines to find desired information, including answers to specific questions. However, given the massive amount of information available on the Internet, users often find themselves overwhelmed with the amount of information a search engine query may return. In addition, someone inquiring about specific goods and/or services (e.g., a user requesting a recommendation for a good camera, a good restaurant, or a good doctor) usually receives results which are based on factors not directly related to the quality of the goods and/or products for which a recommendation was requested, and these results are typically based on recommendations by individuals unfamiliar with the user's preferences, traits and/or needs.

Some users turn to online communities in an attempt to find help in making informed choices. Today, one can join an online community focusing on almost any area of interest, ranging from various hobbies to dating, to health related issues, and even to numerous aspects of commerce. People seeking information relating to a specific issue may join an online community focusing on that issue, and may ask members of that community about the desired information. However, recommendations of online community members may not always be useful. In particular, different members of the community provide different information, advice or recommendations, and it may be difficult for the user posing the question to properly aggregate and analyze information being provided concurrently from multiple sources and to identify which information or suggestion is most relevant to his or her needs. In addition, the person seeking a recommendation on a specific issue may require an immediate answer and may not have time to wait for members of a community to respond to his or her inquiry. Further, community members providing recommendations may be unfamiliar with the inquirer's personal characteristics, preferences and/or traits, and therefore their recommendations may not be customized to the specific needs of the inquirer.

Therefore, it would be advantageous to provide an improved recommendation system that enables users to receive customized recommendations from trusted sources.

### SUMMARY OF THE INVENTION

According to one aspect of the present invention, an exemplary method for providing customized recommendations includes transforming ratings provided by users for an object of interest into one or more correlated recommendations based on the level of trust of the recommendation recipient towards the users, and presenting the correlated recommendations to the recommendation recipient.

### BRIEF DESCRIPTION OF THE DRAWINGS

Embodiments of the invention are illustrated by way of example, and not by way of limitation, in the figures of the accompanying drawings and in which like reference numerals refer to similar elements and in which:

FIG. 1 illustrates an exemplary network architecture in which embodiments of the present invention may operate;

FIGS. 2A and 2B illustrate different configurations of a recommendation system according to some embodiments of the present invention.

FIG. 3 is a block diagram of one embodiment of a recommendation system;

FIG. 4 is a flow diagram of one embodiment of a process for providing customized recommendations to users;

FIG. 5 is a flow diagram of one embodiment of a process for transforming rating provided by trusted users for an object into correlated recommendations;

FIG. 6 is a flow diagram of one embodiment of a process for adjusting correlated recommendations based on the number of ratings provided for corresponding items;

FIGS. 7A and 7B are flow diagrams of two embodiments of a process for collecting user recommendations;

FIG. 8 is a flow diagram of one embodiment of a process for identifying a set of users that a recommendation recipient is likely to trust;

FIG. 9 is a flow diagram of one embodiment of a process for automatically determining the level of trust of a user towards other members;

FIGS. 10A-10F show exemplary user interfaces illustrating a registration process according to some embodiments of the present invention;

FIGS. 11A-11F show exemplary user interfaces illustrating a process of providing customized recommendations to a user, according to some embodiments of the present invention; and

FIG. 12 is a block diagram of one embodiment of a computer system.

### DESCRIPTION OF EMBODIMENTS

A method and apparatus for providing customized recommendations to users is described. In the following description, for purposes of explanation, numerous specific details are set forth in order to provide a thorough understanding of the present invention. It will be apparent, however, to one skilled in the art that the present invention can be practiced without these specific details.

Some portions of the detailed descriptions that follow are presented in terms of algorithms and symbolic representations of operations on data bits within a computer system's registers or memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “calculating” or “determining” or the like, may refer to the action and processes of a computer system, or similar electronic computing device, that manipulates and transforms data represented as physical (electronic) quantities within the computer system's registers and memories into other data similarly represented as physical quantities within the computer-system memories or registers or other such information storage, transmission or display devices.

In the following detailed description of the embodiments, reference is made to the accompanying drawings that show, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, logical, and electrical changes may be made without departing from the scope of the present invention. Moreover, it is to be understood that the various embodiments of the invention, although different, are not necessarily mutually exclusive. For example, a particular feature, structure, or characteristic described in one embodiment may be included within other embodiments. The following detailed description is, therefore, not to be taken in a limiting sense, and the scope of the present invention is defined only by the appended claims, along with the full scope of equivalents to which such claims are entitled.

Although the below examples may describe protection of privacy of networked devices containing management subsystems in the context of execution units and logic circuits, other embodiments of the present invention can be accomplished by way of software. For example, in some embodiments, the present invention may be provided as a computer program product or software which may include a machine or computer-readable medium having stored thereon instructions which may be used to program a computer (or other electronic devices) to perform a process according to the present invention. In other embodiments, processes of the present invention might be performed by specific hardware components that contain hardwired logic for performing the processes, or by any combination of programmed computer components and custom hardware components.

Thus, a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, a transmission over the Internet, electrical, optical, acoustical or other forms of propagated signals (e.g., carrier waves, infrared signals, digital signals, etc.) or the like.

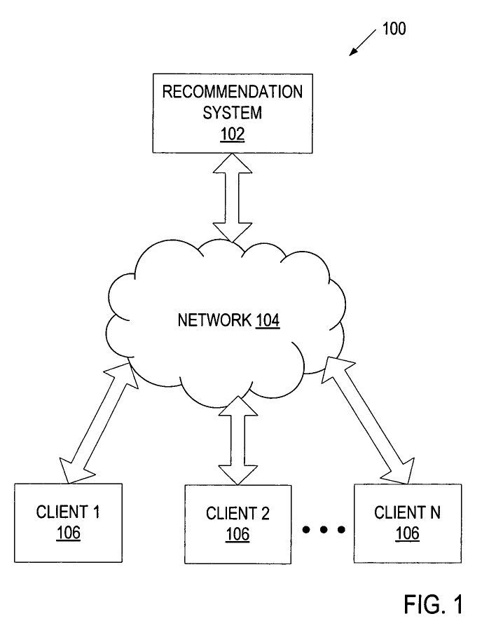

FIG. 1 illustrates an exemplary network architecture 100 in which embodiments of the present invention may operate. The network architecture 100 may include client devices 106 coupled with a recommendation system 102 via a network 104 (e.g., a public network such as the Internet, a private network such as a local area network (LAN), a cable television network, a satellite television network, etc.). The client devices 106 may be, for example, personal computers (PCs), mobile phones, palm-sized computing devices, personal digital assistants (PDAs), set-top boxes, television sets or other consumer electronic devices, etc.

Users of some or all clients 106 are subscribers of the recommendation system 102. The recommendation system 102 receives ratings concerning various objects from the users, stores these ratings in a database, and then uses the stored ratings to provide customized recommendations for specific objects to the users. A rating indicates a user characterization of an object. A rating may be presented in the form of a numerical value or a text description and may pertain to an object's quality, price, availability, or any other parameter. An object may represent a category, a sub-category, a specific item within a category or sub-category, or any other target that may become a subject of a recommendation request. Exemplary categories may include consumer goods and products of various types (e.g., automotive products, sporting goods, etc.), services and service providers (attorneys, doctors, etc.), leisure planning areas (restaurants, movies, hotels, air lines etc.), websites (portals, online services, vertical sites, etc.), etc.

As will be discussed in more detail below, when a user requests a recommendation for a specific object of interest, the recommendation system 102 finds ratings provided for the object of interest by subscribers that are likely to be trusted by this user, transforms these ratings into correlated recommendations based on the level of trust of the user towards the subscribers and other factors, and presents the correlated recommendations to the user. The term “recommendation” as used herein refers to any opinion or suggestion with respect to a target. Such an opinion or suggestion may, for example, be positive (e.g., indicating that the target is advisable), negative (e.g., indicating that the target is not advisable), or neutral (e.g., indicating that the target is neither advisable nor non-advisable).

The subscribers who are likely to be trusted by the user may include, for example, personal friends of the user or other people whose opinion the user may consider when evaluating a specific object. The ratings provided for the object of interest may be ratings of items associated with the object of interest. For example, if the object of interest is “automobiles”, then ratings of items associated with this object of interest are ratings of specific automobile models (e.g., ratings of BMW 525i, ratings of Toyota Camry, ratings of Honda Accord, etc.). The recommendation system 102 may present to the user a list of items (e.g., BMW 525i, Toyota Camry, Honda Accord, etc.) recommended for the object of interest (e.g., automobiles) with corresponding correlated recommendations that reflect relevance of each recommendation to this user. As will be discussed in more detail below, in one embodiment, each item in the list is paired with a correlated recommendation that is calculated based on ratings provided by the trusted subscribers for the relevant item.

Accordingly, the recommendation system 102 allows a user to inquire about a certain object, automatically analyzes and aggregates recommendations associated with the inquiry, and presents to the user a list of recommendations correlated to reflect relevance of these recommendations to that specific user.

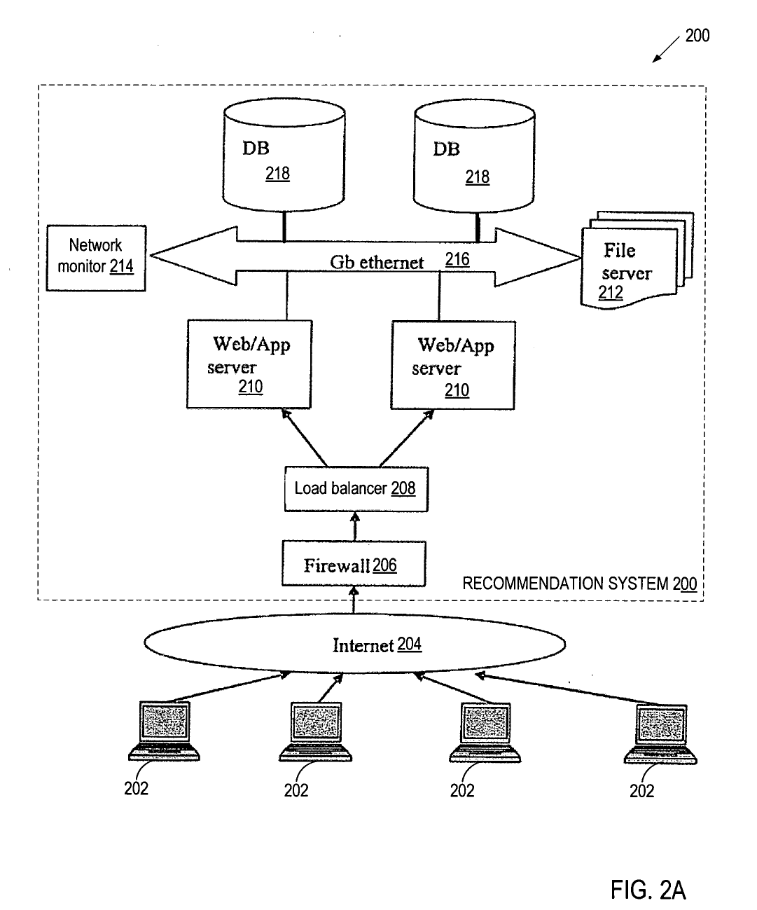

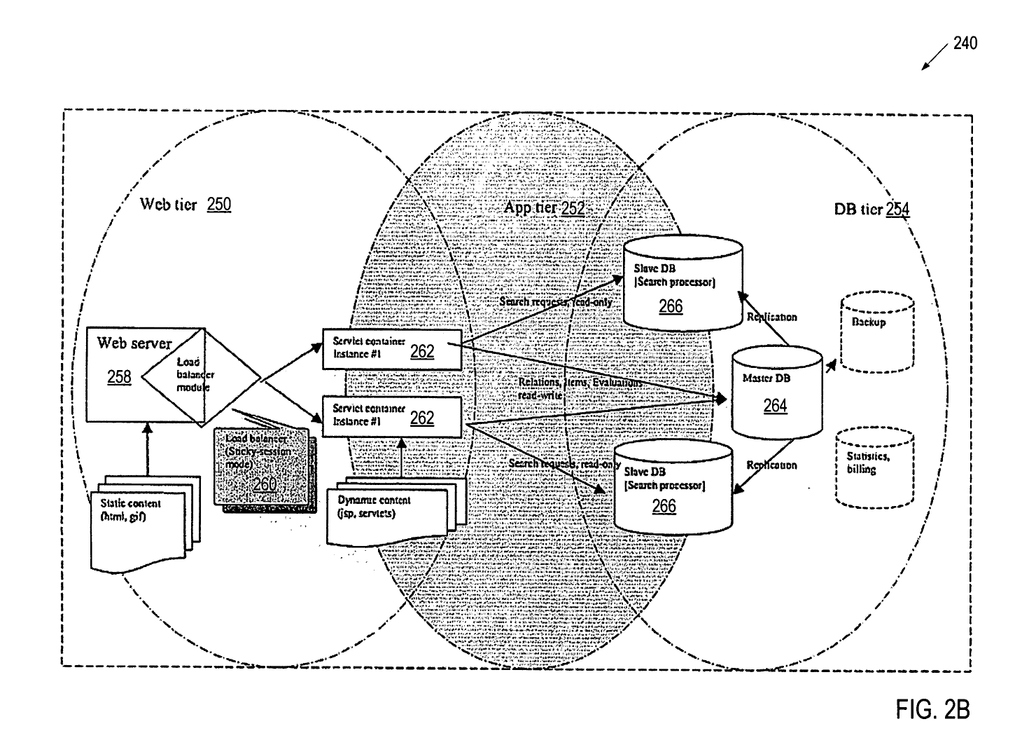

FIGS. 2A and 2B illustrate different configurations of a recommendation system according to some embodiments of the present invention.

Referring to FIG. 2A, a recommendation system 200 is coupled to client devices 202 via a public network such as the Internet 204. The recommendation system 200 includes a firewall 206 that prevents unauthorized users from accessing the recommendation system 200. The firewall 206 passes valid requests from clients 202 to a load balancer 208 that distributes the requests between web/application servers 210. The web/application severs 210 are coupled to databases 218 and file servers 212 via a local area network such as Ethernet 216. A network monitor 214 monitors communications between the databases 208, the web/application servers 210, and the file servers 212. The web/application severs 210 evaluate client requests. If a request includes data provided by the user (e.g., ratings for objects, relationships between users, etc.), the web/application servers 210 pass this data to the databases 218 and/or file servers 212 for storage. If a request asks for a recommendation concerning an object, the web/application servers 210 issue a search request to the databases 218 and/or the file servers 212 to obtain ratings associated with the object, and then transforms these ratings into correlated recommendations that will be presented to the user.

Referring to FIG. 2B, a recommendation system 240 contains three tiers: a web tier 250 that represents the front-end of the recommendation system 240, a database tier 254 that represents the back-end of the recommendation system 240, and an application tier 252 that provides an intelligent interface between the front-end and the back-end.

The web tier 250 includes a web server 258 that receives client requests and delivers web pages (e.g., markup language documents) to the clients. A load balancer 260 balances client requests and passes them to appropriate applications of the application tier 252.

The application tier 252 uses servlet containers 262 to provide data received from clients to the database tier 254 and to issue search requests for content requested by clients to search processors 206. Data received from clients is stored in a master database 264 and may include, for example, items being evaluated, user ratings of the items, relationships between users, etc. The search processors 266 replicate data from the master database 264 and search this data according to client requests (e.g., to obtain user ratings of specific items).

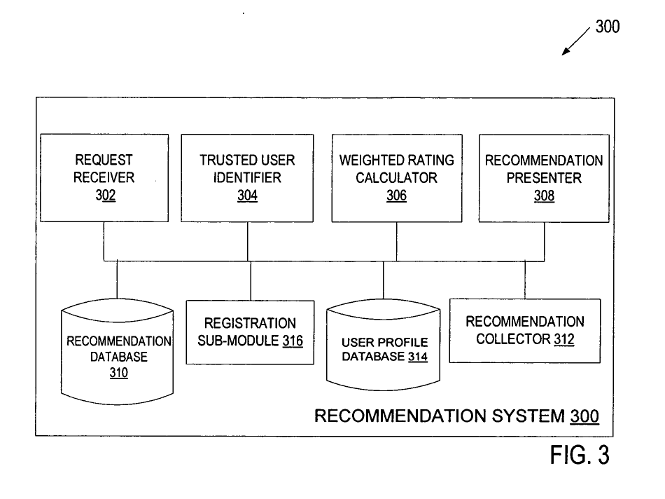

FIG. 3 is a block diagram of one embodiment of a recommendation system 300. The recommendation system 300 includes a request receiver 302, a trusted user identifier 304, a weighted rating calculator 306, a recommendation presenter 306, a recommendation collector 312, a recommendation database 312, a user profile database 314, and a registration sub-module 316.

The registration sub-module 316 handles registration of new users. In one embodiment, any user can register with the recommendation system 300. Alternatively, only users satisfying predefined criteria (e.g., only users invited by existing members) can register with the recommendation system 300 to protect the recommendation system from entities pursuing commercial interests or for other reasons. The registration sub-module 316 collects user preferences and stores them in the user profile database 314.

In one embodiment, the registration sub-module 316 also asks the user to invite individuals the user trusts to join the recommendation system 300. The user may invite these individuals by, for example, sending an email or an IM message. In another embodiment, the user may identify the trusted individuals to the registration sub-module 316 (e.g., in an email address book or an IM roster), which will then automatically send a message with an invitation to register with the recommendation system 300 to each of these individuals. In yet another embodiment, the registration sub-module 316 may automatically identify individuals that the user is likely to trust by evaluating user communications with others (e.g., email messages, phone calls, IM messages, etc.) or other parameters, and then either automatically register the identified individuals with the recommendation system 300 or invite the identified individuals to register with the recommendation system 300. The registration sub-module 316 stores data identifying trusted individuals in the user profile database 314.

In one embodiment, the registration sub-module 316 also asks the user to specify his or her level of trust towards each invited individual, and then stores this information in the user profile database 314. Alternatively, the registration sub-module 316 may automatically determine the user level of trust towards each invited individual by evaluating the communications between the user and the invited individual (e.g., the frequency of communications, the nature of communications, etc.), profiles of the user and invited individuals, behavioral patterns of the user and each invited individual (e.g., whether they have visited the same web sites, purchased the same products online, responded similarly to online surveys, etc.), and various other similar factors and combinations thereof. In addition, the registration sub-module 316 may obtain various other characteristics of invited individuals (e.g., expertise in specific areas, behavioral patterns, common past, common interests, common occupation, etc.) and store these characteristics in the user profile database 314. In one embodiment, the recommendation system 300 periodically re-evaluates the user level of trust to each invited individual using the factors described above. In addition, the recommendation system 300 continues to collect characteristics of invited individuals during their usage of the system after the registration is completed.

In one embodiment, the registration sub-module 316 may also ask the new user to provide a number of ratings as part of the registration process, and then store these ratings in the recommendation database 310. For example, the new user may be allowed to select an object (e.g., a restaurant, a car, a hotel, etc.), and then provide a rating for one or more items associated with this object (e.g., ratings for specific car models or specific restaurants).

The recommendation collector 312 is responsible for collecting ratings from existing users of the recommendation system 300. For example, the recommendation collector 312 may send a request for ratings to an existing user upon determining that this user has received a predefined number of recommendations from the recommendation system 300. In addition, the recommendation collector 312 may periodically identify new (popular) objects or objects that have an insufficient number of ratings and ask users to rate those items. As will be discussed in more detail below, in one embodiment, a user-friendly wizard is provided that motivates users to rate specific items (e.g., items sponsored by manufacturers, popular items, etc.). Upon receiving the ratings, the recommendation collector 312 stores them in the recommendation database 310, along with information identifying the rating providers and the time (e.g., timestamps) of obtaining the ratings.

The request receiver 302 is responsible for receiving user requests concerning objects of interest and parsing the requests to identify the objects of interest and the identity of the users that are interested in these objects. The requests concerning objects of interest may include user requests for recommendations or system-generated requests for recommendations. A system-generated request may be triggered when a user access a certain website, enters a certain part of a website, or performs some other action.

The trusted user identifier 304 is responsible for identifying other users that a recommendation recipient is likely to trust and then retrieving ratings provided for the requested object by the trusted users from the recommendation database 310. In one embodiment, the trusted user identifier 304 identifies trusted users by first associating users with different trust circles. The association may be performed based on input provided by the recommendation recipient, or based on relationships inferred from communications of the recommendation recipient with other users, or based on other parameters. For example, the trusted user identifier 304 may associate users identified by the recommendation recipient as trusted with the first circle of trust (the closest circle of trust). These users may be personal friends of the recommendation recipient and/or some other individuals whose opinion the recommendation recipient may rely on when evaluating various objects. Further, the trusted user identifier 304 may associate users identified by each user from the first circle as trusted with the second circle of trust, and so on. The association may continue until a predefined number of circles of trust is created (e.g., four circles of trust). Alternatively, the association may continue until the number of users associated with the circles of trust exceeds a predefined threshold.

In another embodiment, the trusted user identifier 304 identifies trusted users without utilizing trust circles, but rather based on communications between the users, behavioral patterns of the users, profiles of the users, and other similar factors. In one embodiment, the trusted user identifier 304 assigns each trusted user a trust coefficient that indicates the level of trust between the recommendation recipient and this user.

In one embodiment, users trusted by the recommendation recipient may include experts in certain fields. The trusted user identifier 304 may identified an expert trusted by the recommendation recipient based on input provided by the recommendation recipient or automatically based on the behavior of the recommendation recipient (e.g., the frequency with which the recommendation recipient accesses web pages presenting the opinion of the expert, the amount of time the recommendation recipient spends viewing the web pages presenting the expert's opinion, etc.).

The weighted rating calculator 306 is responsible for transforming ratings provided by the trusted users for the object of interest into one or more correlated recommendations based on the level of trust of the recommendation recipient towards corresponding trusted users. As discussed above, the level of trust may be specified by the recommendation recipient (e.g., during the registration process or when a corresponding trusted user joins the recommendation system 300). In one embodiment, the level of trust may coincide with the identifier of the circle of trust to which the user belongs. Alternatively, the level of trust may be different from the identifier of the circle of trust. For example, users A and B may both be personal friends of recommendation recipient C and as such belong to trust circle 1. However, recommendation recipient C may assign a higher level of trust to user A because recommendation recipient C trusts the opinion of user A more than the opinion of user B.

In one embodiment, the weighted rating calculator 306 uses some other factors, in addition to the level of trust, when transforming the ratings of trusted users into correlated recommendations. These factors may include, for example, knowledge or expertise of a trusted user in the field of inquiry, a period of time since the given rating was provided, the number of ratings provided for this object, features of similarity between the recommendation recipient and other users, etc. Some embodiments of transforming ratings of trusted users into correlated recommendations will be discussed in more detail below.

The recommendation presenter 306 is responsible for presenting the correlated recommendations to the recommendation recipient. The correlated recommendations may be presented to the user with corresponding items recommended for the object of interest and may reflect relevance of each recommendation to the recommendation recipient. The recommended items may be ordered by correlated recommendations. The recommendation recipient may be allowed to select a specific item from the list to obtain more detailed information about the selected item.

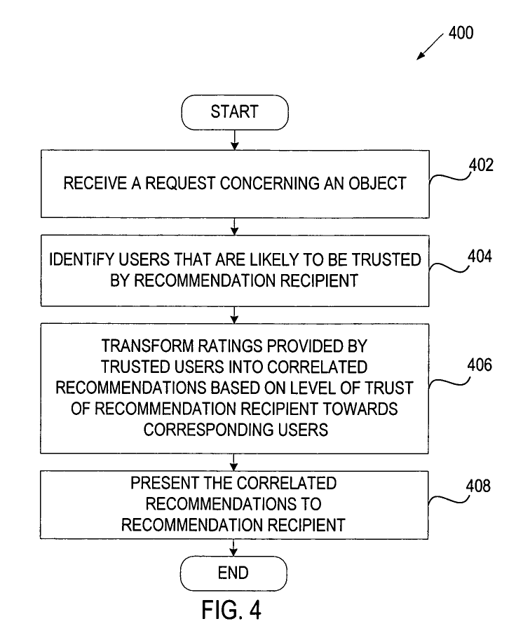

FIG. 4 is a flow diagram of one embodiment of a process 400 for providing customized recommendations to users. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 400 is performed by a recommendation system 300 of FIG. 3.

Referring to FIG. 4, process 400 begins with processing logic receiving a request concerning an object of interest (block 402). The request concerning an object of interest may be a user request for recommendation or a system-generated request for recommendation.

A system-generated request may be triggered when a user access a certain website, enters a certain part of a website, or performs some other action. An object of interest may represent a category (e.g., an attorney), a sub-category (e.g., a patent attorney), a specific item within a category or sub-category (e.g., attorney A, B and C), or any other target that may become a subject of a recommendation request.

Alternatively, block 402 may not be part of process 400. For example, if the recommendation system only maintains ratings for a single object of interest (e.g., movies), a request identifying such a single object of interest may not be needed.

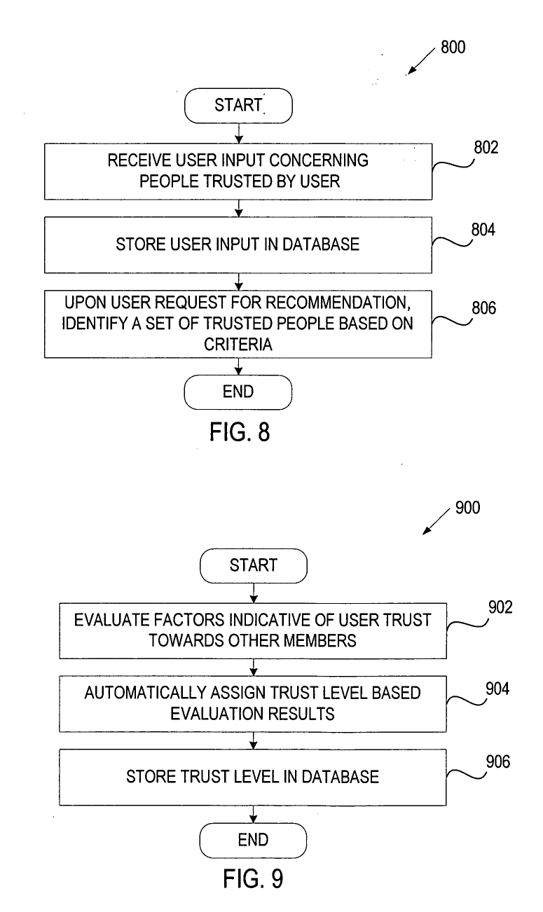

At block 404, processing logic identifies users that are likely to be trusted by the recommendation recipient. The trusted users may be friends of the recommendation recipient, members of the same community such as a church community or alumni community, or any other individuals whose opinion the recommendation recipient may rely on when looking for advice or making a choice. The trusted users may be identified based on input provided by the recommendation recipient. Alternatively, processing logic may identify the trusted users by evaluating communications of the recommendation recipient (e.g., email messages, IM messages, online chats or forums communication, sent greeting cards, mobile phone calls, voice over IP (VoIP) calls, video calls, etc.) or evaluating the recommendation recipient's relationships defined by any kind of a social network or by other parameters. One embodiment of a process for identifying trusted users will be discussed in more detail below in conjunction with FIG. 8.

At block 406, processing logic transforms ratings provided by the trusted users for the object of interest into one or more correlated recommendations based on the level of trust of the recommendation recipient towards corresponding trusted users. In one embodiment, prior to transforming ratings, processing logic first identifies a set of items associated with the object of interest and retrieves ratings provided for these items of interest by the trusted users. The set of items may be specified in the request or found in the database based on the object of interest.

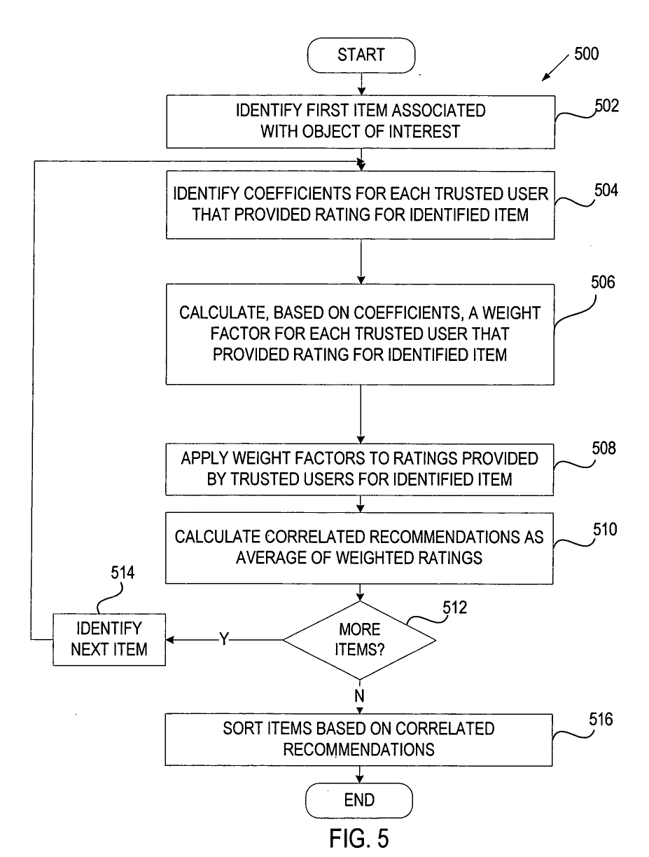

The level of trust may be specified by the recommendation recipient or inferred by processing logic based on the frequency and nature of communications between the recommendation recipient and the trusted users or based on other parameters. In one embodiment, processing logic uses additional factors, along with the level of trust, when transforming the ratings of trusted users into correlated recommendations. These factors may include, for example, knowledge or expertise of a trusted user in the field of inquiry, a period of time since the given rating was provided, the number of ratings provided for this object, features of similarity between the recommendation recipient and other users, etc. One embodiment of a process for transforming ratings of trusted users into correlated recommendations will be discussed in more detail below in conjunction with FIG. 5.

At block 408, processing logic presents the correlated recommendations to the recommendation recipient. The correlated recommendations may be presented to the recommendation recipient with corresponding items recommended for the object of interest. The correlated recommendations reflect relevance of each recommendation to the recommendation recipient. The presented data may be ordered by correlated recommendations.

FIG. 5 is a flow diagram of one embodiment of a process 500 for transforming rating provided by trusted users for an object of interest into correlated recommendations. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 500 is performed by a recommendation system 300 of FIG. 3.

Referring to FIG. 5, process 500 begins with processing logic finding a set of items associated with the object of interest and identifying the first item in this set (block 502).

Next, processing logic identifies coefficients for each trusted user that provided rating for the identified item (block 504). The coefficients correspond to various factors. Exemplary factors may include a level of trust, knowledge or expertise of a trusted user in the field of inquiry, a period of time since the given rating was provided, the number of ratings provided for this object, features of similarity between a recommendation recipient and other users, etc.

One embodiment of calculating a trust level coefficient will now be discussed in more detail. In particular, for a trust level coefficient W(d), a linear dependence of trust circle identifier d is used, where a value of 1 is assigned to the first trust circle and some predefined value c is assigned to the last trust circle (the trust circle=4). The value of “c” is a subject of tuning. For distance>4, c drops to 0.

$$For 0 < d <= 4 \text{:} w = 1 - ( 1 - c ) \frac{d - 1}{3} where 0 < c < 1 \\ For d > 4 \text{:} w = 0 \qquad ( 1 )$$

[image]

One embodiment of calculating a timing coefficient for a period of time since the given rating was provided will now be discussed in more detail. This coefficient is referred to herein as a date of rating (DoR) coefficient. As more time passes from the DoR, the smaller the DoR coefficient becomes. First, the DoR is transformed into the number of days that have passed since the rating was provided:
DoRD=TODAY−DoR+1 (2)

In one embodiment, the coefficient derived from DoRD is specific to item's sub-category. The quality of certain services may be more volatile than others, at the same time the quality of consumer goods can hardly be considered volatile. The following reverse quadratic formula may be used to calculate the timing coefficient:

$$w = \frac{1}{( γ {x}^{2} + δ )} + c ; 0 < γ < 1 , c < 0 < 1 , \\ δ = \frac{1}{1 - c} \qquad ( 3 )$$

If c=C, γ=G, then C is a final weight (at infinity); G is a slope factor. Diagram 2 below shows WDoR for C=0.5 and G=(0.001, 0.0003, 0.0001).

[image]

If the timing coefficient is not used, WdoR may be set to 1. Alternatively, a linear function may be used that is illustrated by the following diagram 3.

[image]

The following formula may be used to calculate a timing coefficient using a linear function, in which C is a final weight, D0 is the number of days before starting to degrade, D1 is the number of days before stopping to degrade at level C.

$$w = 1 - ( 1 - c ) \frac{d - {d}_{0}}{{d}_{1} - {d}_{0}} where {d}_{0} < d < {d}_{1} \\ w = 1 where d < {d}_{0} \\ w = r where d > {d}_{1} \qquad ( 4 )$$

One embodiment of calculating a user expertise coefficient UE will now be discussed in more detail. In one embodiment, UE is calculated using automated assessment of user expertise. Such UE, referred to as an automated user expertise coefficient (AUE), depends on the number of evaluations made by the user within the same sub-category or category as the item being evaluated, or the total number of items evaluated by the user, or some predefined selection of categories/subcategories that may or may not relate to the item being evaluated. In one embodiment, AUE of a user is derived based on the user's data such as the user's education or occupation, the field of expertise provided by the user, etc.

In one embodiment, AUE is specific to item's sub-category, and different “expertise” thresholds may be used depending on sub-category. For example, a person who rated 3 restaurants may not be considered as a restaurant expert while a person who rated 3 dentists may be considered as a dentist expert. AUE may be determined by first calculating the number of user ratings NUE made within the same sub-category. Then, a piecewise-linear function is applied to calculate we(e)=AUE, where R is an expert's rating (1<R<2), N0 is the number of ratings before starting to upgrade, N1 is the number of ratings before stopping to upgrade at expert level R.

$$we ( e ) = AUE = 1 + ( R - 1 ) \frac{n - {n}_{0}}{{n}_{1} - {n}_{0}} where {n}_{0} < n < {n}_{1} \\ we ( e ) = AUE = 1 where n < {n}_{0} \\ we ( e ) = AUE = R where n > {n}_{1} \qquad ( 5 )$$

[image]

In another embodiment, UE is determined using manual assessment of user expertise. Such UE, referred to as manual user expertise coefficient (MUE), depends on MUE factor manually assigned by the recommendation recipient to the user. The factor may start from the value of 0 (no expertise) and go up to some pre-defined positive value (an expert). Since the value of we(e)=MUE is explicitly defined by the user, no formula is needed. MUE may vary from 0 to MAX_MUE, where 0 indicates that the evaluations of this user should be discarded and MAX_MUE indicates that this user is an expert.

In yet another embodiment, a composite assessment of UE (CUE) is calculated by multiplying AUE by MUE, thus combining both “objective/absolute” and “subjective/relative” factors. The value of we(e)=CUE is calculated according to the following formula:
we(e)=CUE=AUE*MUE (6)

Referring again to FIG. 5, at block 506, processing logic calculates a weight factor for each trusted user based on the above coefficients. In one embodiment, processing logic calculates a weight factor for a trusted user by multiplying the coefficients associated with the trusted users.

Next, processing logic applies weight factors to ratings provided by corresponding trusted users for the first item (block 508) and calculates a correlated recommendation for the item as an average of weighted ratings (block 510). In one embodiment, a simple average is calculated as a scalar value using the following formula in which a set of values {V}ₙ={v₁, v₂, . . . , vₙ}, and an associated set of weights {W}ₙ={w₁, w₂, . . . , wₙ}, so that each wᵢ is non-negative and at least one wᵢ is positive and n is the number of evaluations.

$$Aw = \frac{{\sum }_{i = 1}^{n} vi * wi}{{\sum }_{i = 1}^{n} wi} \qquad ( 7 )$$

In another embodiment, a composite average is calculated for multiple weighted factors. Every wᵢ is a product of the corresponding single weight, which can be calculated using the following formula, were m is the number of single types of weights per evaluation:

$${w}_{i} = {\prod }_{j = 1}^{m} {w}_{ij} \qquad ( 8 )$$

If the rated value is r, and weights wt(t), we(e), wd(d) are certain functions of t, e, d respectively, with each of these weights being either a constant or decrease or a combination of both, then the composite average may be calculated using the following formula:

$$Rt = \frac{{\sum }_{i = 1}^{n} {r}_{i} * {w}_{i}}{{\sum }_{i = 1}^{n} {w}_{i}} \qquad ( 9 )$$

where wᵢ=wtᵢ(t)*weᵢ(e)*wdᵢ(d)*wx(x).

Still referring to FIG. 5, if processing logic determines that there are more rated items associated with the object of interest (block 512), processing logic identifies the next item rated by at least one trusted user (block 514) and returns to block 504. Otherwise, processing logic sorts the items based on corresponding correlated recommendations calculated at block 510 (block 516), and process 500 ends.

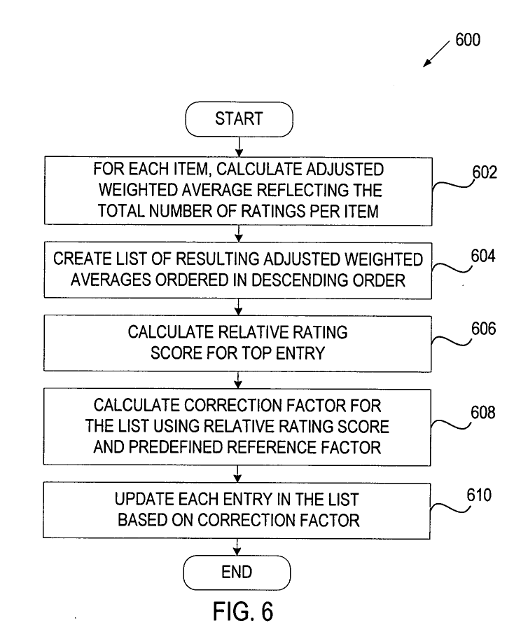

FIG. 6 is a flow diagram of one embodiment of a process 600 for adjusting correlated recommendations based on the number of ratings provided for corresponding items. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 600 is performed by a recommendation system 300 of FIG. 3.

Referring to FIG. 6, process 600 begins with calculating, for each rated item, an adjusted weighted average reflecting the total number of existing ratings per item (block 602). In one embodiment, in order to take into account the number of ratings (the more ratings are given, the more objective is their composite weighted average value) and to guarantee that the result depends on all involved parameters in every exceptional case (e.g., when all ratings are at the same level, or all ratings were provided at the same time, etc.), the following adjustment formula can be used:

$$Rt = \frac{{\sum }_{i = 1}^{n} {r}_{i} * {w}_{i} + {R}_{0} * D}{{\sum }_{i = 1}^{n} {w}_{i} + D} \qquad ( 10 )$$

where wᵢ=wtᵢ(t)*weᵢ(e)*wdᵢ(d)*wx(x), R₀ is some predefined ideal Reference Rating, and weight D=wd(1)+wd(2)+wd(3)+wd(4), with wd(1) corresponding to trust circle 1, wd(2) corresponding to trust circle 2, etc.

Weight D is defined to guarantee that the result depends on all involved parameters in every exceptional case. By using formula (10), the number of ratings is taken into account such that the more ratings are provided for the item, the less weight Reference Rating has in the formula, and therefore the closer is the relative rating to ratings given to the item. In addition, the more ratings are given to the item, the more objective is the result. Hence, if the number of ratings is high, the result is close to composite weighted average value in accordance with formula (9). If the number of ratings is lower, the result becomes closer to the Reference Rating as a set of real ratings can be considered non-representative.

Next, processing logic normalizes the relative ratings to eliminate the influence of the Reference Rating. In particular, processing logic creates a list of resulting weighted averages ordered in the descending order (block 604), with the top item (the item with the largest Rₜ) taken as a reference item with its rating equal to Rₜ. Then, processing logic calculates a relative ranking score Rᵣ for the top entry in the list using formula (9) (block 606). Further, processing logic calculates a correction factor Fc for the list using the relative rating score Rᵣ and a predefined reference factor Fᵣ₂ (e.g., if Rᵣ>6, Fᵣ₂=5, otherwise Fᵣ₂=0.5) (block 608). Correction factor Fc may be calculated using the following formula:
F_{c}=(Rᵣ−Fᵣ₂)/(Rᵣ−Fᵣ₂) (11)

Afterwards, processing logic updates each entry in the list using the correction factor Fc (block 610).

In another embodiment, the process of adjusting correlated recommendations based on the number of ratings does not include the normalization discussed above. Instead, a correlated recommendation is adjusted using an additional coefficient corresponding to the number of ratings stored for a relevant item. For example, for 1-4 ratings per item, a ratings number coefficient of 0.5 may be used for a relevant recommendation; for 5-10 ratings per item, a ratings number coefficient of 0.75 may be used for a relevant recommendation; and for more than 10 ratings per item, a ratings number coefficient of 1.0 may be used for a relevant recommendation.

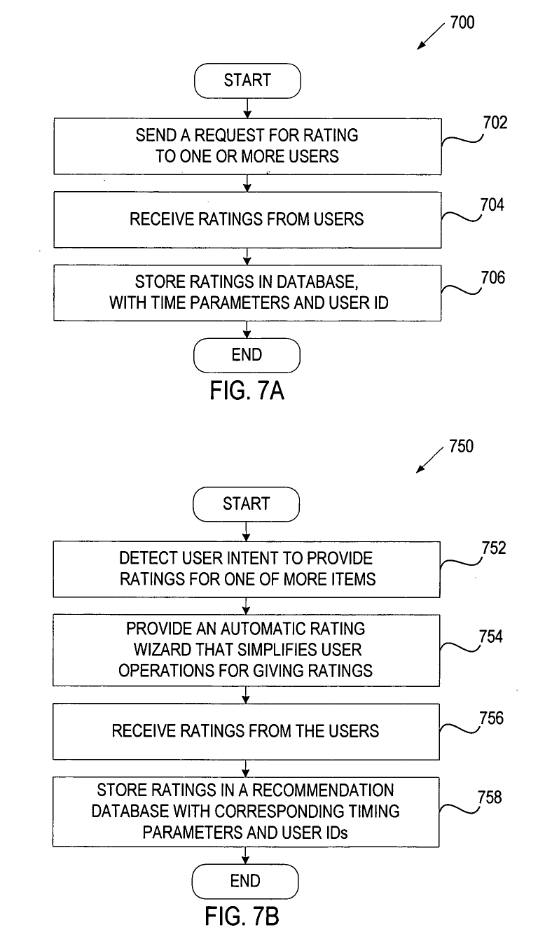

FIGS. 7A and 7B are flow diagrams of two embodiments of a process for collecting user recommendations. The process may be performed by processing logic that may comprise hardware (e.g., circuitry, dedicated logic, programmable logic, microcode, etc.), software (such as that run on a general purpose computer system or a dedicated machine), or a combination of both. In one embodiment, the process is performed by a recommendation system 300 of FIG. 3.

Referring to FIG. 7A, process 700 begins with sending a request to provide ratings to one or more users (block 702). In one embodiment, the request is sent to a new user when the new user registers with the recommendation system, and asks the new user to provide a predefined number of ratings for a category and/or sub-category selected by the user or for a specific category, sub-category or item. In another embodiment, processing logic sends a request for ratings to an existing user upon determining that this user has received a predefined number of recommendations from the recommendation system. In yet another embodiment, processing logic sends requests for ratings on behalf of a user to members trusted by this user (e.g., the user's first circle of friends) to recommend a specific item or several items in a specific category. In still another embodiment, processing logic periodically identifies new (popular) categories or items, or existing categories or items that have an insufficient number of ratings, and request users to rate those items. A user-friendly rating wizard may be used to motivate users to provide ratings. A wizard may be used as a tool for achieving various business goals of an organization. For example, an organization maintaining the recommendation system 102 may use the rating wizard to obtain consumers' opinions with respect to certain products and then sell those opinions to a product manufacturer. In another example, a product manufacturer may maintain the recommendation system 102 and use the rating wizard to conduct testing of their new products (e.g., if a toothpaste manufacturer sells a new toothpaste in Chicago, the rating wizard may be used to push users of the recommendation system who reside in Chicago to rate the new toothpaste, thus allowing the toothpaste manufacturer to obtain objective consumer opinion about the new toothpaste).

Next, processing logic receives ratings from the users (block 704) and stores these ratings in a recommendation database with corresponding timing parameters (e.g., timestamps) and user IDs (block 706).

Referring to FIG. 7B, process 750 begins with processing logic detecting user intent to provide ratings for one or more items (block 752). In one embodiment, the user intent is detected when the user selects an option to add a rating for a new item. In another embodiment, the user intent is detected when the user selects an option to add a rating for an existing item (e.g., an item identified to the user by processing logic).

Upon detecting the user intent to provide ratings, processing logic provides an automatic rating wizard that simplifies user operations for providing ratings (block 754). For example, for a new item, the wizard allows the user to select a category of the new item, and then lists various options for data to be specified for this new item so that the user can merely select the desired options rather than manually entering data for various fields.

Next, processing logic receives ratings from the users (block 756) and stores these ratings in a recommendation database with corresponding timing parameters (e.g., timestamps) and user IDs (block 758).

FIG. 8 is a flow diagram of one embodiment of a process 800 for identifying a set of users that a recommendation recipient is likely to trust. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 800 is performed by a recommendation system 300 of FIG. 3.

Referring to FIG. 8, process 800 begins with receiving user input concerning people trusted by the user (block 802). In one embodiment, this input is provided when the user registers with the recommendation system. In one embodiment, processing logic may also ask the user to provide input concerning a specific individual when this individual joins the recommendation system. Alternatively, processing logic may periodically ask the user to view a list of members that have recently joined the recommendation system and identify the members that the user trusts. In still another embodiment, processing logic may periodically ask the user to invite new members this user trusts to join the system.

At block 804, processing logic stores the user input in a user profile database. In one embodiment, in which a social network is maintained to reflect relationships among members, processing logic updates the social network based on the user input.

At block 806, processing logic identifies a set of members that the user is likely to trust upon receiving a request pertaining to an object of interest. In one embodiment, processing logic identifies trusted members by first associating members with different trust circles. The association may be performed based on input provided by the user and other members or based on relationships inferred from communications of the user with other members. The number of trusted users may be limited by the number of circles of trust (e.g., only 4 circles of trust can be considered when identifying trusted people) or by the number of trusted members (e.g., only 50 members can be included in the set of trusted people). Alternatively, the above criteria may be combined. For example, the combined criteria may require that members be included in the set of trusted people until the set exceeds 50 members or until the fifth level of trust is reached. In one embodiment, the set of trusted people is extended to include members with similar interests. In particular, processing logic may compare the behavior of the user requesting the recommendation with the behavior of other members (e.g., in a specific category or in all categories). If members with similar behavior are found, they may be included in the set of trusted members. Alternatively, they may be processed separately from the trusted members. That is, processing logic may calculate separate correlated recommendations based on ratings provided by members with similar interests, and then show these correlated recommendations separately from other recommendations.

In one embodiment, when processing logic finds members with similar interests, it asks these members if they want to include each other in their respective circles of trust.

In one embodiment, processing logic allows users to join groups of interest (e.g., extreme sports, hiking, computer geeks etc) or automatically add the users to those groups based on interests they identified in their profiles. Processing logic may then assume that members of a group have some kind of trust relationships to each other in relevant to this group categories (e.g., group members may be treated as 2^{nd} circle friends, or group members may specify which circle they belong to). Subsequently, processing logic will consider their ratings in these categories while calculating weighted average. Alternatively, the user may specify whether these ratings should be considered or not. For example, the user may request that only ratings of close friends be considered.

Calculation of similarity between users will now be discussed in more details. In one embodiment, similarity between two users is defined using a correlation coefficient between the ratings of these two users in the same category. Although various correlation coefficients may be used as a measure of similarity, an exemplary correlation coefficient known as the product moment coefficient of correlation or Pearson's correlation will be used to illustrate how an embodiment of the present invention operates.

If we assume that n ratings {x} are made by user A and n ratings {y} are made by user B, so that each pair of ratings (xᵢ, yᵢ) points to the same item, then the correlation coefficient can be expressed as follows:

$$r = \frac{n \sum xy - \sum x \sum y}{\sqrt{[ n \sum {x}^{2} - {( \sum x )}^{2} ] [ n \sum {y}^{2} - {( \sum y )}^{2} ]}} \qquad ( 12 )$$

Then, rating r will be in a range from −1 to 1, where −1 means the rating patterns are absolutely not similar, 1 means perfect correlation, and 0 means that they are independent.

Formula (12) will now be illustrated using exemplary 10 ratings of users A and B in Tables 1 and 2.

TABLE 1

| | User A | User B |
|---|---|---|
| | X | Y |
| Movie 1 | 1 | 2 |
| Movie 2 | 2 | 3 |
| Movie 3 | 8 | 8 |
| Movie 4 | 5 | 7 |
| Movie 5 | 5 | 6 |
| Movie 6 | 6 | 6 |
| Movie 7 | 7 | 4 |
| Movie 8 | 4 | 3 |
| Movie 9 | 9 | 8 |
| Movie 10 | 0 | 1 |

The ratings in Table 1 provide an example of good correlation, resulting in R(A,B)=0.874498.

TABLE 2

| | User A | User B |
|---|---|---|
| | X | Y |
| Movie 1 | 1 | 8 |
| Movie 2 | 2 | 7 |
| Movie 3 | 8 | 2 |
| Movie 4 | 5 | 9 |
| Movie 5 | 5 | 2 |
| Movie 6 | 6 | 1 |
| Movie 7 | 7 | 2 |
| Movie 8 | 4 | 8 |
| Movie 9 | 9 | 1 |
| Movie 10 | 1 | 8 |

The ratings in Table 2 provide an example of poor correlation, resulting in R(A,B)=−0.78662.

In one embodiment, formula (12) is only used for overlapped ratings and for standard deviations of {x} (DX) and {y} (DY) that are non-zero (not if all {x} or all {y} are the same). In addition, formula (12) may not provide adequate results in case of low (ay less then 1) standard deviations (when rating values are in the range from 1 to 10). In the examples shown in Tables 1 and 2 the deviation is between 2 and 3. Table 3 illustrates a case with lower deviation.

TABLE 3

| | User A | User B |
|---|---|---|
| 10 | X | Y |
| Movie 1 | 6 | 8 |
| Movie 2 | 6 | 8 |
| Movie 3 | 5 | 8 |
| Movie 4 | 6 | 7 |
| Movie 5 | 6 | 8 |
| Movie 6 | 6 | 8 |
| Movie 7 | 6 | 8 |
| Movie 8 | 6 | 8 |
| Movie 9 | 6 | 8 |
| Movie 10 | 6 | 8 |

For ratings in Table 3, correlation factor R(A,B)=−0.11111, and both standard deviations D(A), D(B) are =0.3. The ratings in Table 3 also show a similarity in the rating pattern—both users are very indiscriminate in their tastes. In one embodiment, when both standard deviations are less then 1, the two users are considered similar.

In one embodiment, the total number of user ratings and the number of overlapping ratings are considered to achieve a more accurate result. In addition, only users having N_MIN ratings in specific category are to be checked and only those user pairs (A, B) that have at least M_MIN (M_MIN<N_MIN) common items rated are mutually checked. Next, a correction coefficient RC(A, B) which depends on M(A,B) is introduced. Finally, the similarity coefficient SC(A, B) will depend on a correlation factor R(A, B) which is calculated over overlapped ratings, standard deviations D(A), D(B) and correction coefficient RC(A, B) as follows:

IF N(A)>=N_MIN AND N(A)>=N_MIN AND M(A< B)>=M_MIN
THEN(

1. IfD(A)<DMIN AND D(B)<DMIN, then SC=1
2. IfD(A)>=DMIN, AND D(B)>=DMIN, then SC=R(A,B)*RC(A, B)
3. Otherwise SC=0

)
OTHERWISE SC=0.

In the above algorithm, DMIN is a minimal threshold standard deviation. For ratings (1 . . . 10), we suggest DMIN=1. RC(A, B) varies from 0 (if ratings do not overlap) till 1 (if multiple ratings overlap). For example, the following formula may be used:
RC(A,B)=1−1/(1+M(A,B)) (13)

Diagram 5 illustrates the behavior of the algorithm utilizing formula (13).

[image]

In one embodiment, prior to calculating the correlation between the users, the number of users qualified for similarity check is optimized. In particular, only users having N ratings in a specific category are to be checked and only those user pairs (A, B) that have at least M (M<N) common items rated are to be mutually checked. For example, for movies users may have to rate at least 10 movies, and a correlation between users A, B may be calculated if they rated at least 5 common movies. If similarity coefficient (SC) for users satisfying the above requirements is greater than 0.5, then such users are considered similar.

In one embodiment, if the users are similar, but not directly connected, these users may be proactively offered to connect directly, referring to their similarity in ratings and a common friend. Alternatively, these users may be asked to provide any other level of trust they would like to assign to each other.

In another embodiment, a similarity coefficient (SC) alone or in combination with trust level coefficient W(d) is taken into account as an additional weight.

FIG. 9 is a flow diagram of one embodiment of a process 900 for automatically determining the level of trust of a user towards other members. The process may be performed by processing logic that may comprise hardware (e.g., circuitry, dedicated logic, programmable logic, microcode, etc.), software (such as that run on a general purpose computer system or a dedicated machine), or a combination of both. In one embodiment, process 900 is performed by a recommendation system 300 of FIG. 3.

Referring to FIG. 9, process 900 begins with processing logic evaluating factors indicative of user trust to other members (block 902). These factors may include, for example, user communications with other members, profiles of the user and other members, behavioral patterns of the user and other members, different combinations of the above factors, etc. The user communications may be email communications, IM communications, online chats or forum communications, sent greeting cards, VoIP communications, video calls, mobile phone communications, etc. Processing logic may evaluate user communications with a specific member based on frequency and type (nature) of these communications. For example, processing logic may distinguish between communications exchanged during work hours and weekend and after-work communications. In addition, processing logic may identify communications including birthday wishes or other friendship indicators. Behavioral patterns may be evaluated by identifying members that visited the same sites as this user, purchased the same products as this user, responded similarly to online surveys, etc.

Various systems may be used when obtaining data to perform the above evaluations. Exemplary systems may include Gmail®, Yahoo!® Mail, Yahoo!® Messenger and Yahoo!® 360 combination, ICQ®, Hotmail®, MSN® Spaces and MSN® Messenger, Skype®, Google® Talk, etc.

At block 904, processing logic automatically assigns the trust level to a specific member based on the evaluation results.

At block 906, processing logic stores the trust level in a user profile database.

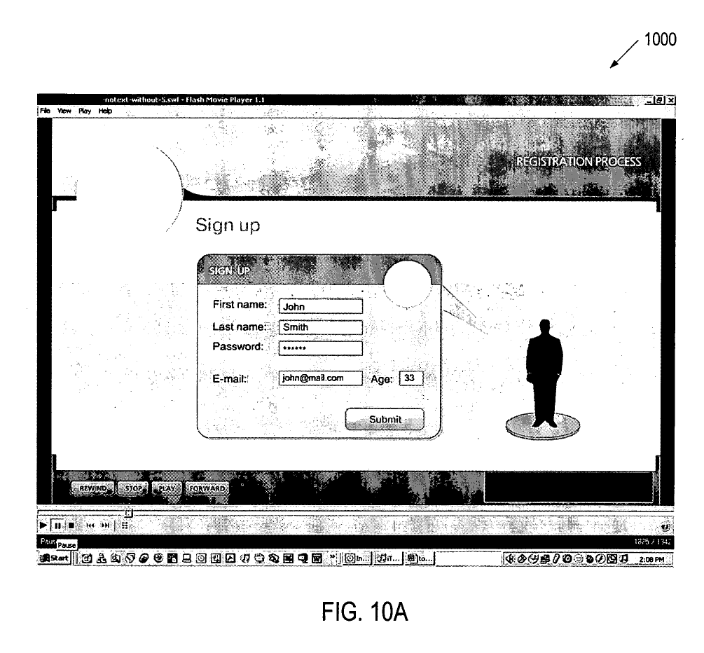

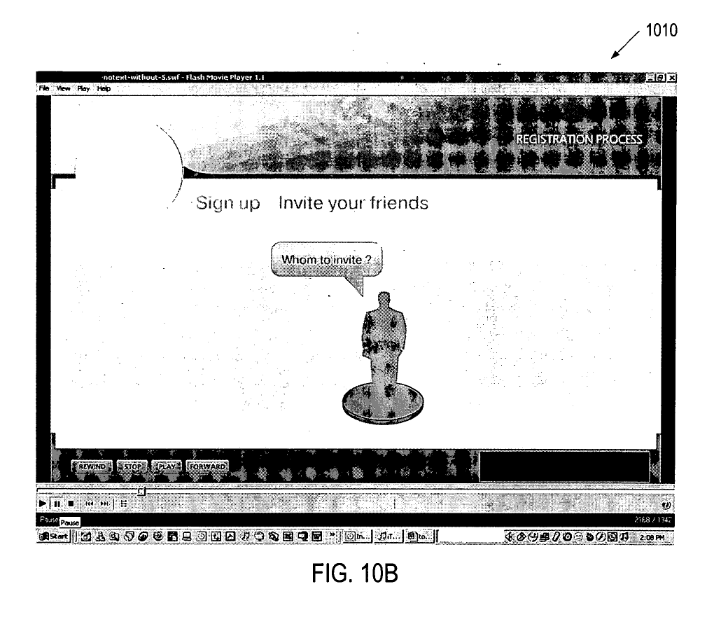

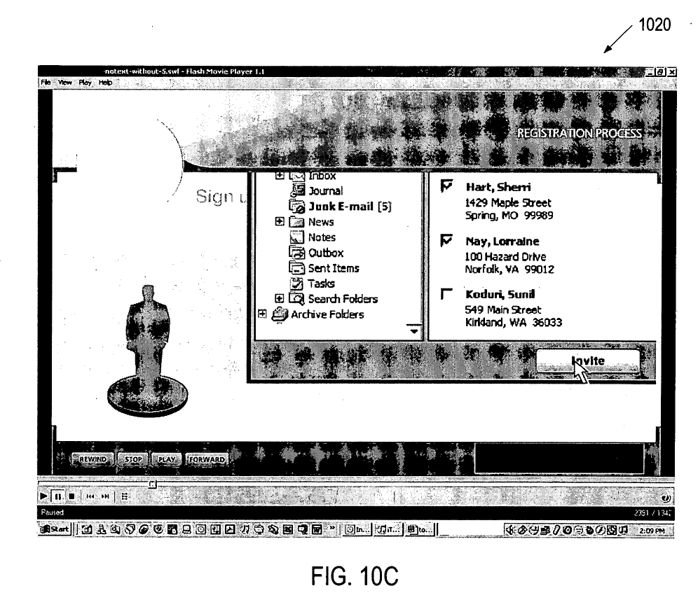

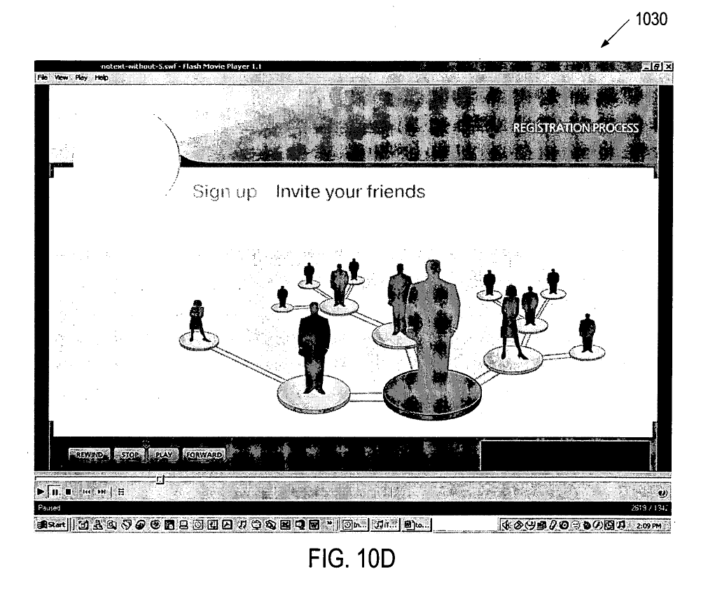

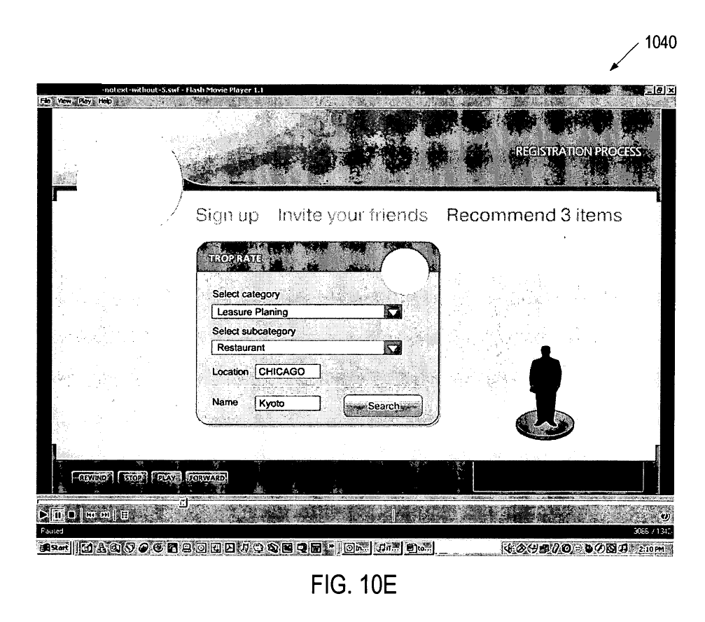

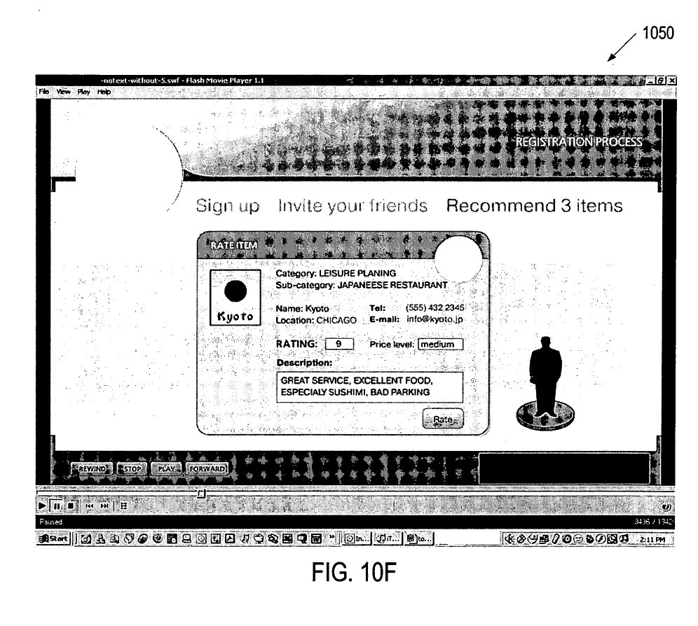

FIGS. 10A-10F show exemplary user interfaces (UIs) illustrating a registration process according to some embodiments of the present invention.

Referring to FIG. 10A, UI 1000 shows exemplary data that a user needs to provide to register with the recommendation system.

Referring to FIG. 10B, UI 1010 allows the user to invite friends to join the recommendation system.

Referring to FIG. 10C, UI 1020 allows the user to select, from his or her address book, contacts that should be invited to join the recommendation system. Upon receiving the user selection, the recommendation system sends invitations to the selected individuals.

Referring to FIG. 10D, UI 1030 provides a visual representation of user relationships with other members.

Referring to FIG. 10E, UI 1040 requests the user to provide 3 recommendations by selecting a category, a sub-category and specifying other parameters specific to this sub-category (e.g., location and name).

Referring to FIG. 10F, UI 1050 allows the user to provide rating, price level, and description for the selected item.

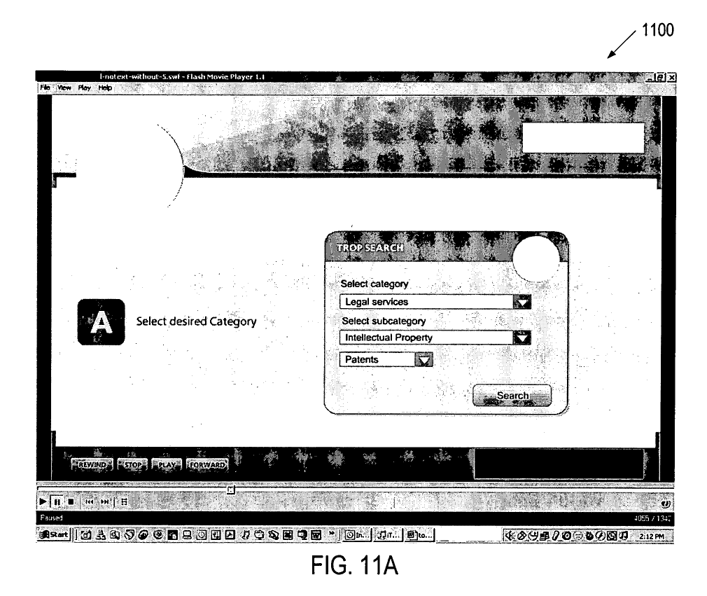

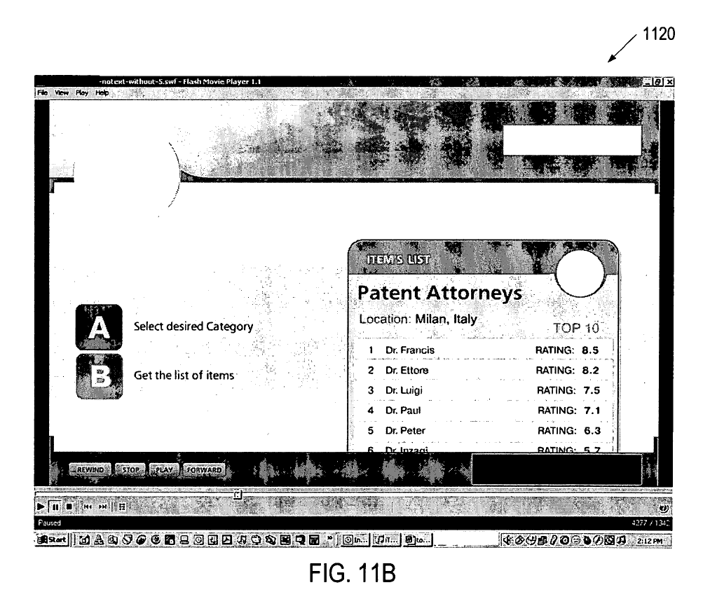

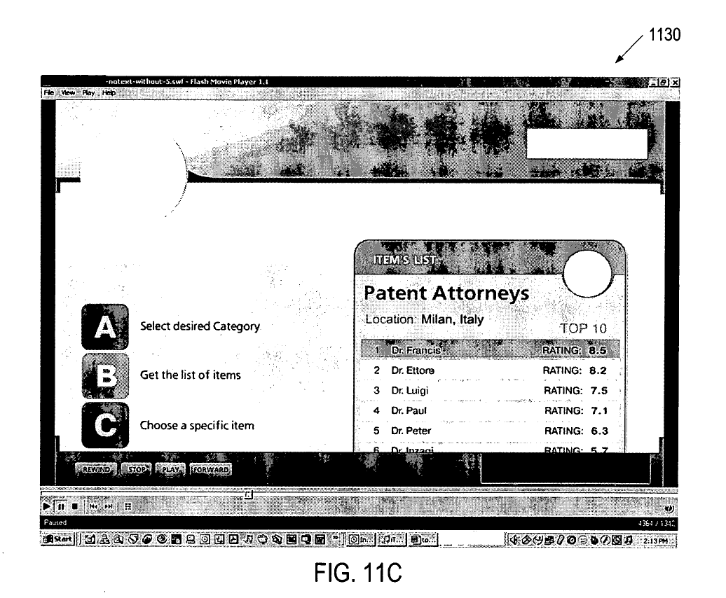

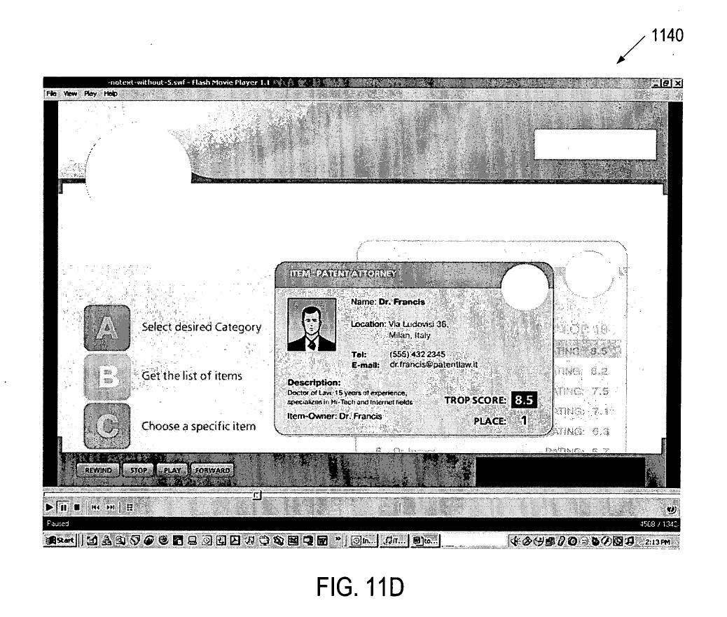

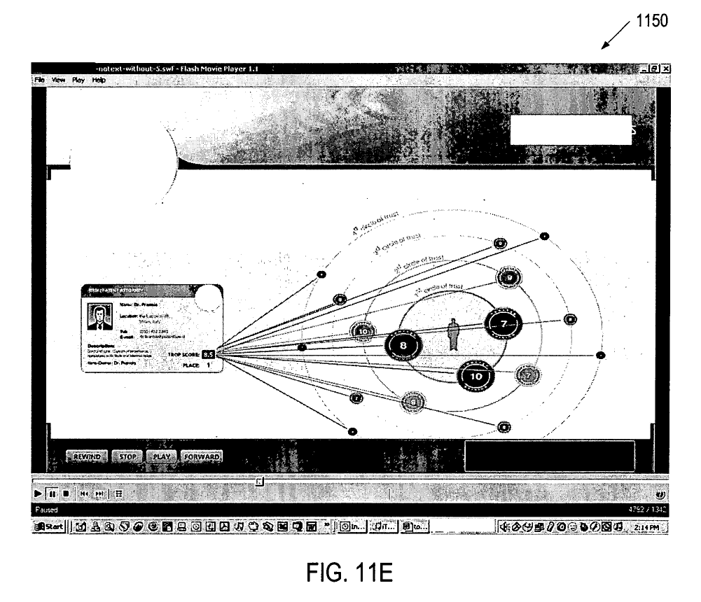

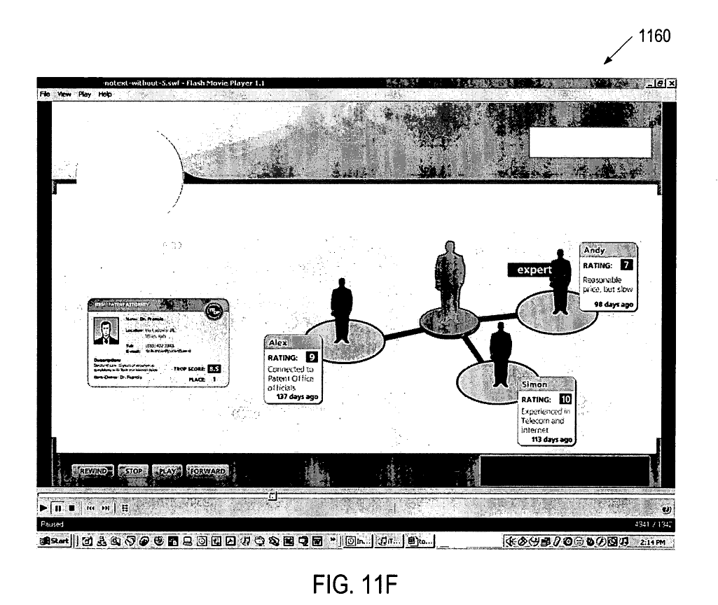

FIGS. 11A-11F show exemplary user interfaces (UIs) illustrating a process of providing customized recommendations to a user, according to some embodiments of the present invention.

Referring to FIG. 11A, UI 1100 allows a user to select a desired category and sub-category.

Referring to FIG. 11B, UI 1120 displays a list of items recommended to the user for the selected category, with corresponding ratings correlated to reflect the relevance of the recommendations to the user.

Referring to FIG. 11C, UI 1130 allows the user to select a specific recommended item from the list.

Referring to FIG. 11D, UI 1140 displays details about the selected item.

Referring to FIG. 11E, UI 1150 provides a visual representation of how ratings of members at different levels of trust contributed to the resulting recommendation.

Referring to FIG. 11F, UI 1160 displays factors associated with members at the first circle of trust that provided ratings for the selected item.

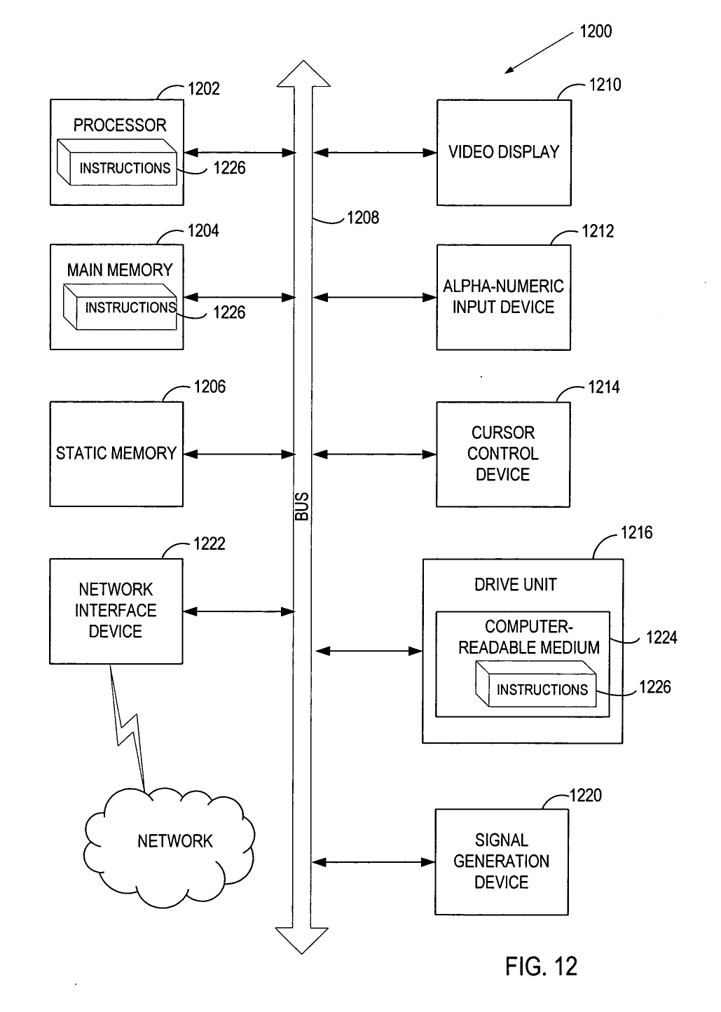

FIG. 12 shows a diagrammatic representation of machine in the exemplary form of a computer system 1200 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1200 includes a processor 1202 (e.g., a central processing unit (CPU), a graphics processing unit (GPU) or both), a main memory 1204 (e.g., read only memory (ROM), flash memory, dynamic random access memory (DRAM) such as synchronous DRAM (SDRAM) or Rambus DRAM (RDRAM), etc.) and a static memory 1206 (e.g., flash memory, static random access memory (SRAM), etc.), which communicate with each other via a bus 1208.

The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a disk drive unit 1216, a signal generation device 1220 (e.g., a speaker) and a network interface device 1222.

The disk drive unit 1216 includes a machine-readable medium 1224 on which is stored one or more sets of instructions (e.g., software 1226) embodying any one or more of the methodologies or functions described herein. The software 1226 may also reside, completely or at least partially, within the main memory 1204 and/or within the processor 1202 during execution thereof by the computer system 1200, the main memory 1204 and the processor 1202 also constituting machine-readable media.

The software 1226 may further be transmitted or received over a network 1228 via the network interface device 1222.

While the machine-readable medium 1224 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Thus, a method and apparatus for providing customized recommendations to users have been described. It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A computerized method comprising:
transforming ratings provided by users for an object of interest into one or more correlated recommendations based, at least in part, on a level of trust of a recommendation recipient towards the users; and
presenting the one or more correlated recommendations to the recommendation recipient.

2. The method of claim 1 wherein the ratings provided by the users include ratings provided by any of the users for one or more items associated with the object of interest.

3. The method of claim 2 wherein transforming ratings provided by the users for the object of interest into one or more correlated recommendations comprises:
for every item associated with the object of interest,
identifying a plurality of coefficients for each user that provided a rating for said item,
calculating, based on the plurality of coefficients, a weight factor for each user that provided a rating for said item,
applying weight factors to ratings of corresponding users for said item, and
calculating a weighted average of resulting weighted ratings for said item.

4. The method of claim 3 wherein the plurality of coefficients comprises coefficients selected from the group consisting of a trust level coefficient, an expertise coefficient, a timing coefficient, a similarity coefficient, and a ratings number coefficient.

5. The method of claim 4 wherein the trust level coefficient is specified by the recommendation recipient or determined automatically.

6. The method of claim 3 wherein transforming ratings provided by the users for the object into one or more correlated recommendations further comprises:
adjusting the weighted average of resulting weighted ratings using a total number of ratings provided for a relevant item.

7. The method of claim 1 further comprising:
identifying, within a plurality of users, users that are likely to be trusted by the recommendation recipient; and
retrieving the ratings provided by the identified users from a database.

8. The method of claim 7 wherein the users that are likely to be trusted by the recommendation recipient are identified based on relationships among the plurality of users within a social network.

9. The method of claim 8 wherein the social network is built based on input of the plurality of users or automatically.

10. The method of claim 7 wherein the users that are likely to be trusted by the recommendation recipient are identified based on virtual relationships among the plurality of users.

11. The method of claim 10 further comprising:
determining the virtual relationships based on factors selected from the group consisting of communications among the plurality of users, profiles of the plurality of users, and behavioral patterns of the plurality of users.

12. The method of claim 11 wherein the communications are selected from the group consisting of email communications, instant messaging (IM) communications, chat communications, voice over IP (VoIP) communications, and mobile phone communications.

13. The method of claim 1 further comprising:
collecting ratings from a plurality users; and
storing the ratings in a database.

14. The method of claim 13 wherein the ratings are collected via at least one of a request to provide a minimum number of recommendations during a user registration, a request to provide at least one recommendation in response to a user receipt of a predefined number of recommendations, and a request to rate a specific item.

15. The method of claim 13 further comprising:
providing a wizard to motivate the plurality of users to provide ratings.

16. The method of claim 1 further comprising:
receiving a request concerning the object of interest.

17. An apparatus comprising:
a weighted rating calculator to transform ratings provided by users for an object of interest into one or more correlated recommendations based, at least in part, on a level of trust of a recommendation recipient towards the users; and
a recommendation presenter to present the one or more correlated recommendations to the recommendation recipient.

18. The apparatus of claim 17 wherein the weighted rating calculator is to transform ratings provided by the users for the object of interest into one or more correlated recommendations by:
for every item associated with the object of interest,
identifying a plurality of coefficients for each user that provided a rating for said item,
calculating, based on the plurality of coefficients, a weight factor for each user that provided a rating for said item,
applying weight factors to ratings of corresponding identified users for said item, and
calculating a weighted average of resulting weighted ratings for said item.

19. The apparatus of claim 18 wherein the plurality of coefficients comprises coefficients selected from the group consisting of a trust level coefficient, an expertise coefficient, a timing coefficient, a similarity coefficient, and a ratings number coefficient.

20. The apparatus of claim 17 further comprising:
a trusted user identifier to identify, within a plurality of users, users that are likely to be trusted by the recommendation recipient.

21. The apparatus of claim 20 wherein the trusted user identifier identifies the users that are likely to be trusted by the recommendation recipient based on virtual relationships among the plurality of users or relationships among the plurality of users within a social network.

22. The apparatus of claim 17 further comprising:
a request receiver to receive a request concerning an object of interest.

23. A machine-readable medium containing instructions which, when executed by a processing system, cause the processing system to perform a method, the method comprising:
receiving a request of a recommendation recipient for a recommendation concerning an object;
transforming ratings provided by users for the object into one or more correlated recommendations based, at least in part, on a level of trust of a recommendation recipient towards the users; and
presenting the one or more correlated recommendations to the recommendation recipient.
